(19) United States
(12) Patent Application Publication
(10) Pub. No.: US 2022/0379624 A1
(43) Pub. Date: Dec. 1, 2022

(54) PRINT MATERIAL USAGE ESTIMATION

(71) Applicant: Hewlett-Packard Development Company, L.P., Spring, TX (US)

(72) Inventors: Ana Cristina Garcia Alvarez, Sant Cugat del Valles (ES); Utpal Kumar Sarkar, Barcelona (ES); Esteban Gallardo Guillen, Sant Cugat del Valles (ES)

(21) Appl. No.: 17/770,758

(22) PCT Filed: Jan. 29, 2020
(86) PCT No.: PCT/US2020/015562

§ 371 Date: Apr. 21, 2022

(51) Int. Cl. B41J 2/175

(52) U.S. Cl. CPC B41J 2/17566

(57) ABSTRACT

A print material usage estimation device may comprise a first usage meter to measure a first print material usage associated with print material deposition on a print medium over a specified time period. 5 The print material usage estimation device may further comprise a second usage meter to measure a second print material usage associated with other printer processes over the specified time period. The print material usage estimation device may further comprise a ratio calculator to calculate a ratio between second print material usage and first print material usage over the specified time period. The print 10 material usage estimation device may further comprise an estimator to estimate total print material usage for an instructed print job based on a predetermined first print material usage for the print job and the calculated ratio.

### BACKGROUND

Many printers may deposit print material onto a print medium. Printing may be carried out by passing the print medium along a printing path, while a printer carriage may be passed over the print medium at a print location along a scan axis. Print media may be made of materials such as paper, Mylar, vinyl and textiles, for example.

Inkjet printers may be provided with printheads for firing or spitting drops of ink or other print material. In thermal inkjet printheads, ink may be ejected from a nozzle for example by using a heater resistor: when an electric voltage is applied, electric current flows through the heater resistor, heats the ink and causes it to eject from the nozzle. The printer may be a latex printer in which the printer ink may include latex or a latex polymer.

Further, additive manufacturing systems may generate three-dimensional objects on a layer-by-layer basis through the selective solidification of a print material, such as build material. In examples of such techniques, print material is supplied in a layer-wise manner and a solidification method may include heating the layers of print material to cause melting in selected regions, for example in regions bearing a fusing agent. In other techniques, other solidification methods, such as chemical solidification methods or binding materials, may be used.

### BRIEF DESCRIPTION OF DRAWINGS

Non-limiting examples will now be described with reference to the accompanying drawings, in which:

FIG. 1 is a simplified schematic of a device according to some examples;

FIG. 2 is another simplified schematic of a device according to some examples; and

FIG. 3 is a flowchart of a method according to some examples.

### DETAILED DESCRIPTION

During the life of a printer, print material may be used for printing (depositing print material on media) and for cleaning printheads in order to keep them in good working order and to improve the firing of the drops with the correct size and directionality, ultimately improving printed image quality. There may be additional print material used for printer calibration and diagnostic prints (which again may include print material being deposited on media, in the form of a calibration print, and printhead cleaning associated with the calibration and diagnostic actions). Further cleaning, in the form of printhead or print material maintenance may also be carried out, which may be triggered either by the user or automatically by the printer.

The print material used for cleaning, calibration and diagnostic purposes may vary significantly between prints, depending on many factors including the state of the print material, the time since the last print and the condition of the printheads. Therefore, the amount of print material used in total for two instances of the same print (printing of the same image) may be different if the amount of print material used for cleaning, calibration and/or diagnostics is different between the two prints. The amount of cleaning may be higher with certain types of printer, for example printers using latex inks may be cleaned more often than those using other ink-based print materials.

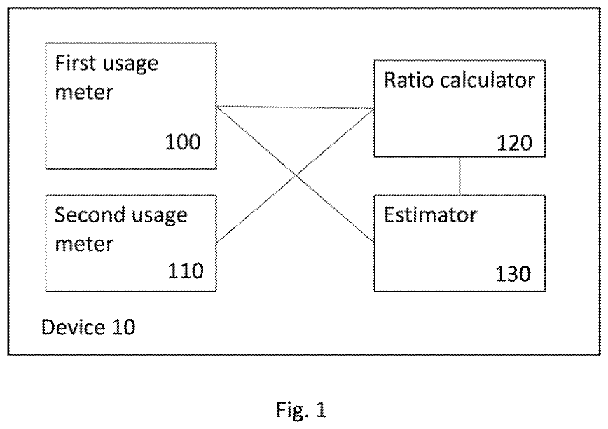

In accordance with some examples, described herein, and shown in FIG. 1, there is provided a device 10. The device 10 may be a print material usage estimation device. The device 10 may comprise a first usage meter 100 to measure a first print material usage associated with print material deposition on a print medium over a specified time period. The device 10 may further comprise a second usage meter 110 to measure a second print material usage associated with other printer processes over the specified time period. The device 10 may further comprise a ratio calculator 120 to calculate a ratio between second print material usage and first print material usage over the specified time period. The device 10 may further comprise an estimator 130 to estimate total print material usage for an instructed print job based on a predetermined first print material usage for the print job and the calculated ratio.

In some examples, the first and second usage meters 100, 110 may be fluid flow meters or other measurement apparatuses. In some examples, the first and second usage meters 100, 110 may count the number of print material drops fired (to be deposited on a print medium) and may determine the volume of each drop fired. Drop volume may depend on factors including the print material used, the architecture of the printhead, and/or the print medium. Further, printhead nozzles may for example be cleaned by applying either pressure or suction for a specific amount of time. The first and second usage meters 100, 110 may measure print material used during such cleaning, by measuring the pressure/suction applied and the specific amount of time to give the used print material volume. The ratio calculator 120 may be a processor or other calculation apparatus. The estimator 130 may be also be a processor. The device 10 may further include a memory or storage device capable of storing measurement results, ratio calculations and estimations, output by each component of the device 10. In some examples, a memory or storage device may be located remotely from the device 10.

In accordance with some examples, the device 10 may be part of, or may be used in conjunction with, an inkjet printer, a laser printer or an additive manufacturing system, such as a 3D printer. In the example of laser printer, the print material may for example be toner.

In some examples, print material usage may be measured over along period of time and then a proportion of that print material usage may be associated with each individual print job (printing a single image, for example).

In a simplified example of a printer operation period, a printer may include instructions to print 20 copies of a first image and 35 copies of a second image. An operator may begin with a single copy of the first image, to check the quality of the print and/or performance of the printer. After printing the single copy of the first image, some banding (or other visual imperfection) for example may occur, so the operator may instruct a printhead cleaning operation to be carried out. Following this cleaning operation, the operator may proceed with a print run of 20 copies of the first image. In most cases, this would then proceed without any issues arising. Next, the operator may instruct a print run of 35 copies of the second image. Following printing, a number of copies may be found to include visible smears or streaks, which may have resulted from the short pause between the first and second print runs or from a problem with at least one of the printheads. The operator may then initiate a further printhead cleaning routine. If the error is not corrected by carrying out the cleaning routine, a number of further actions may be taken including replacing the problematic printhead with a new printhead. Following replacement, the remaining copies of the second image may be printed without any issues. Finally, due to an external factor (unrelated to the printing), a single copy of the first image may be damaged and should be reprinted. Therefore, the operator may instruct a single copy of the first image to be printed.

Each of the above-described print runs may include an associated “set-up” amount of print material usage, with further usage associated with the various cleaning and maintenance procedures carried out. Therefore, for each individual printed page, or for each unit of print material used to print an image, the amount of print material used for associated or other operations, which ensure high quality prints, may vary significantly. Therefore, the unit cost of each copy of the first image, when printed as 20 identical copies in quick succession, may be significantly lower than the single copy printed last. This may lead to unpredictable print material usage for a given print job, which may have an effect on associated costs.

According to some examples, predictability of average print material usage, for a given job may be improved, which may also allow for more predictable cost estimating for a print job and long-term print material supply planning.

In some examples, the specified time period may include at least a threshold number of cleaning, calibration and/or diagnostic actions.

In order for the sample period (the specified time period) to have a suitable number of different print-related actions, a minimum number of cleaning, calibration and/or diagnostic actions may be set. This may reduce the likelihood of “outlier” actions affecting the estimation. Before beginning the depositing of print material onto a print medium, the printer may check the printhead status of each printhead and, based on the nozzle health, carry out different cleaning and maintenance actions, which may carry significantly different associated print material usage amounts. Similarly, calibration and diagnostic actions may also vary significantly in their associated print material usage. Including a minimum number of such actions may reduce variations in the sample taken, on which the usage estimate is based. In this way, proportional associated print material usage may be more usefully estimated for a print job.

In some examples, the specified time period may include at least a threshold number of previously executed print jobs.

A minimum number of print jobs may be set in order for the sample period to include a suitable number of different print jobs and associated actions.

In some examples, other print processes may include at least one of actions associated with cleaning, calibration and diagnostics.

Other print processes may include any action involving the use (consumption) of print material, other than the actual depositing of print material onto a print medium.

In some examples, the estimator 130 may estimate print material usage associated with other print processes for the instructed print job.

As well as estimating total print material usage, associated with a specific print job, the estimator 130 may estimate the print material usage other than that deposited on the print medium, as part of the print job.

According to some examples, it may be possible to anticipate more accurately print material needs for a production plan (a sequence of print jobs).

According to examples described above, variations in print material usage of two identical print jobs may be reduced.

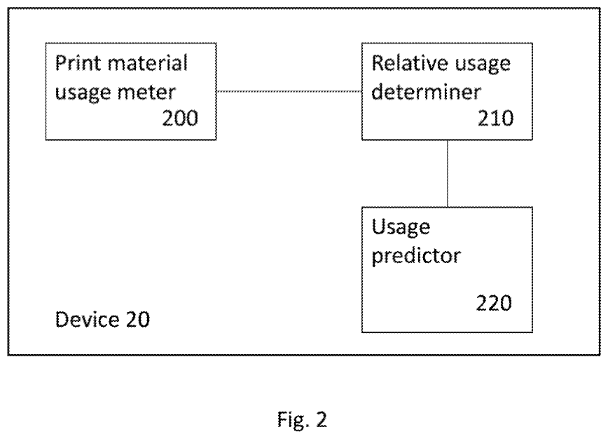

In accordance with some examples, described herein, and shown in FIG. 2, there is provided a device 20. The device 20 may be a print material usage prediction device. The device 20 may comprise a print material usage meter 200 to measure print material usage associated with print material deposition over a time period and to measure print material usage associated with printer functions other than print material deposition over the time period. The device 20 may further comprise a relative usage determiner 210 to determine an amount of print material used for printer functions other than print material deposition per unit of print material used for print material deposition, based on the measurements. The device 20 may further comprise a usage predictor 220 to predict print material usage for a print job, based on the determination.

In some examples, it may be possible to predict print material usage, based on an amount of print material to be deposited on a print medium, in association with a print job, and the above determination. A print job, or instructions for a print job, may include a calculable amount of print material to be deposited on a print medium. This, combined with a determined amount of print material used for printer functions other than print material deposition per unit of print material used for print material deposition, may allow print material usage for the print job to be predicted.

In some examples, the print material usage meter 200 may be a fluid flow meter or other print material consumption measurement apparatus. The relative usage determiner 210 may be a processor or other determination apparatus. The usage predictor 220 may be also be a processor. The device 20 may further include a memory or storage device capable of storing measurement results, ratio calculations and estimations, output by each component of the device 20. In some examples, a memory or storage device may be located remotely from the device 20.

In some examples, the usage predictor may predict print material usage associated with other print processes for the print job.

Print material usage associated with other print processes for the print job may be predicted on the basis of the determination above.

In some examples, the time period may include at least a threshold number of cleaning, calibration and/or diagnostic actions. In some further examples, the time period may include at least a threshold number of previously executed print jobs.

Setting a minimum threshold number of associated actions or previously carried out print jobs may reduce variations between different predictions.

In some examples, other print processes may include at least one of actions associated with cleaning, calibration and diagnostics.

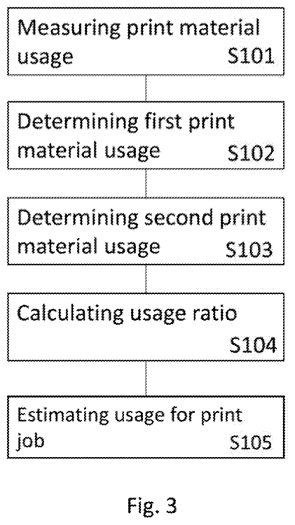

In accordance with some examples, described herein, there is provided a method as shown in FIG. 3. The method may be a print material usage estimation method. The method may comprise measuring S101 print material usage over a specified period. The method may further comprise determining S102 a first print material usage associated with print material deposition on a print medium over the specified period. The method may further comprise determining S103 a second print material usage associated with other printer processes over the specified period. The method may further comprise calculating S104 a ratio between second print material usage and first print material usage over the specified period. The method may further comprise estimating S105 print material usage for an instructed print job based on a predetermined first print material usage for the print job and the calculated ratio.

In accordance with the method, print material usage may be measured over along period of time and, for the print jobs carried out during that period, a portion of the print material usage may be associated with an individual print job (printing a single image, for example). Print material usage, which forms part of the total usage during execution of the print job, but may not be directly related to depositing print material onto a print medium, may then be estimated as a proportion of the total print material usage for a given print job.

In some examples, the estimating S105 may comprise estimating print material usage associated with other print processes for the instructed print job.

In some examples, the specified period may include at least a threshold number of cleaning, calibration and/or diagnostic procedures or previously executed print instructions.

In some examples, other print processes may include at least one of procedures associated with cleaning, calibration and diagnostics.

In some further examples, there may be provided a program which, when executed on a processor, may cause the processor to carry out the method as describe above.

The device 10, 20 may be included as part of a printer or printer controller, or may be separate from a printer which is to carry out the print job.

Examples in the present disclosure can be provided as methods, systems or machine readable instructions, such as any combination of software, hardware, firmware or the like. Such machine readable instructions may be included on a computer readable storage medium (including but not limited to disc storage, CD-ROM, optical storage, etc.) having computer readable program codes therein or thereon.

The present disclosure is described with reference to flow charts and/or block diagrams of the method, devices and systems according to examples of the present disclosure. Although the flow diagrams described above show a specific order of execution, the order of execution may differ from that which is depicted. Blocks described in relation to one low chart may be combined with those of another low chart. It shall be understood that each flow and/or block in the flow charts and/or block diagrams, as well as combinations of the flows and/or diagrams in the flow charts and/or block diagrams can be realized by machine readable instructions.

The machine readable instructions may, for example, be executed by a general purpose computer, a special purpose computer, an embedded processor or processors of other programmable data processing devices to realize the functions described in the description and diagrams. In particular, a processor or processing apparatus may execute the machine readable instructions. Thus functional modules of the apparatus and devices may be implemented by a processor executing machine readable instructions stored in a memory, or a processor operating in accordance with instructions embedded in logic circuitry. The term ‘processor’ is to be interpreted broadly to include a CPU, processing unit. ASIC, logic unit, or programmable gate array etc. The methods and functional modules may all be performed by a single processor or divided amongst several processors.

Such machine readable instructions may also be stored in a computer readable storage that can guide the computer or other programmable data processing devices to operate in a specific mode.

Such machine readable instructions may also be loaded onto a computer or other programmable data processing devices, so that the computer or other programmable data processing devices perform a series of operations to produce computer-implemented processing, thus the instructions executed on the computer or other programmable devices realize functions specified by flow(s) in the flow charts and/or block(s) in the block diagrams.

Further, the teachings herein may be implemented in the form of a computer software product, the computer software product being stored in a storage medium and comprising a plurality of instructions for making a computer device implement the methods recited in the examples of the present disclosure.

While the method, apparatus and related aspects have been described with reference to certain examples, various modifications, changes, omissions, and substitutions may be made without departing from the scope of the present disclosure. It is intended, therefore, that the methods, devices and related aspects be limited only by the scope of the following claims and their equivalents. It should be noted that the above-mentioned examples illustrate rather than limit what is described herein, and that those skilled in the art will be able to design many alternative implementations without departing from the scope of the appended claims.

The word “comprising” does not exclude the presence of elements other than those listed in a claim, “a” or “an” does not exclude a plurality, and a single unit may fulfil the functions of several units recited in the claims.

The features of any dependent claim may be combined with the features of any of the independent claims or other dependent claims.

1. A print material usage estimation device comprising:
a first usage meter to measure a first print material usage associated with print material deposition on a print medium over a specified time period;
a second usage meter to measure a second print material usage associated with other printer processes over the specified time period;
a ratio calculator to calculate a ratio between second print material usage and first print material usage over the specified time period; and
an estimator to estimate total print material usage for an instructed print job based on a predetermined first print material usage for the print job and the calculated ratio.

2. The print material usage estimation device of claim 1, wherein the specified time period includes at least a threshold number of cleaning, calibration or diagnostic actions.

3. The print material usage estimation device of claim 1, wherein the specified time period includes at least a threshold number of previously executed print jobs.

4. The print material usage estimation device of claim 1, wherein other print processes include at least one of actions associated with cleaning, calibration or diagnostics.

5. The print material usage estimation device of claim 1, wherein the estimator is to estimate print material usage associated with other print processes for the instructed print job.

6. A print material usage prediction device comprising:
a print material usage meter to measure print material usage associated with print material deposition over a time period and to measure print material usage associated with printer functions other than print material deposition over the time period;
a relative usage determiner to determine an amount of print material used for printer functions other than print material deposition per unit of print material used for print material deposition, based on the measurements; and
a usage predictor to predict print material usage for a print job, based on the determination.

7. The print material usage prediction device of claim 6, wherein the usage predictor is to predict print material usage associated with other print processes for the print job.

8. The print material usage prediction device of claim 6, wherein the time period includes at least a minimum threshold number of cleaning, calibration or diagnostic actions.

9. The print material usage prediction device of claim 6, wherein the time period includes at least a minimum threshold number of previously executed print jobs.

10. The print material usage prediction device of claim 6, wherein other print processes include at least one of actions associated with cleaning, calibration or diagnostics.

11. A print material usage estimation method comprising:
measuring print material usage over a specified period;
determining a first print material usage associated with print material deposition on a print medium over the specified period;
determining a second print material usage associated with other printer processes over the specified period;
calculating a ratio between second print material usage and first print material usage over the specified period; and
estimating print material usage for an instructed print job based on a predetermined first print material usage for the print job and the calculated ratio.

12. The print material usage estimation method of claim 11, wherein the estimating comprises estimating print material usage associated with other print processes for the instructed print job.

13. The print material usage estimation method of claim 11, wherein the specified period includes at least a minimum threshold number of cleaning, calibration or diagnostic procedures.

14. The print material usage estimation method of claim 11, wherein the specified period includes at least a minimum threshold number of previously executed print instructions.

15. The print material usage estimation method of claim 11, wherein other print processes include at least one of procedures associated with cleaning, calibration or diagnostics.
